(19) United States
(12) Patent Application Publication
(10) Pub. No.: US 2026/0285138 A1
(43) Pub. Date: Sep. 24, 2026

(54) MOUNTING APPARATUS

(71) Applicant: ISUZU MOTORS LIMITED, Yokohama-shi (JP)

(72) Inventors: Takuya FUJIWARA, Fujisawa-shi (JP); Takahiro SEKIUCHI, Fujisawa-shi (JP)

(21) Appl. No.: 19/531,729

(22) Filed: Feb. 6, 2026

(30) Foreign Application Priority Data
Mar. 21, 2025 (JP) 2025-047002

(51) Int. Cl. B60K 1/04

(52) U.S. Cl. CPC B60K 1/04; B60K 2001/0461

(57) ABSTRACT

A mounting apparatus includes: a coupling bracket fixed to a vehicle body frame and formed with a fastened portion; a mounting portion coupled to the coupling bracket and configured to mount a battery so as to be movable in a vehicle width direction; a fixing bracket removably attached to the coupling bracket; an elastic body fixed to the fixing bracket and interposed between the battery positioned on an inner side in the vehicle width direction and the coupling bracket; and a fastening member configured to fasten the fixing bracket to which the elastic body is fixed to the coupling bracket by being fastened to the fastened portion.

### CROSS-REFERENCE TO RELATED APPLICATIONS

The present application claims priority to Japanese Patent Applications number 2025-47002, filed on March 21, 2025 contents of which are incorporated herein by reference in their entirety.

### BACKGROUND OF THE INVENTION

The present disclosure relates to a mounting apparatus. A vehicle in which a battery serving as a power source for driving an electric motor is supported by the vehicle body frame has been used. Japanese Unexamined Patent Application Publication No. 2005-190957 discloses a structure in which the battery is supported via vibration-proof rubber that is a deformable elastic body.

In recent years, it has been proposed to support a replaceable battery removably on a vehicle body frame. When an elastic body supports the battery in contact therewith, the elastic body tends to be worn down through attachment and detachment of the battery, thereby requiring replacement of the elastic body.

### BRIEF SUMMARY OF THE INVENTION

The present disclosure has been made in view of these points, and its object is to easily replace an elastic body in a mounting apparatus configured to support a battery in a replaceable manner.

One aspect of the present disclosure provides a mounting apparatus including: a first bracket fixed to a vehicle body frame and formed with a fastened portion; a mounting portion coupled to the first bracket and configured to mount a battery so as to be movable in a vehicle width direction; a second bracket removably attached to the first bracket; an elastic body fixed to the second bracket and interposed between the battery positioned on an inner side in the vehicle width direction and the first bracket; and a fastening member configured to fasten the second bracket to which the elastic body is fixed to the first bracket by being fastened to the fastened portion.

### BRIEF DESCRIPTION OF THE DRAWINGS

FIG. 1 is a schematic diagram illustrating a vehicle 1 according to one embodiment.

FIG. 2 is a perspective view showing a mounting apparatus 10 on which a replaceable battery 5 is placed.

FIG. 3 is a perspective view showing the mounting apparatus 10 with the replaceable battery 5 removed.

FIG. 4 is a plan view of the mounting apparatus 10 shown in FIG. 2.

FIG. 5 is a view showing a state in which a rubber unit 50 is fixed to a coupling bracket 15.

FIG. 6 is a plan view of the coupling bracket 15 and the rubber unit 50 shown in FIG. 5.

FIG. 7 is a view showing the coupling bracket 15 with the rubber unit 50 removed.

FIG. 8 is an exploded view of the rubber unit 50.

### DETAILED DESCRIPTION OF THE INVENTION

Hereinafter, the present disclosure will be described through exemplary embodiments, but the following exemplary embodiments do not limit the invention according to the claims, and not all of the combinations of features described in the exemplary embodiments are necessarily essential to the solution means of the invention

### Overview of a vehicle

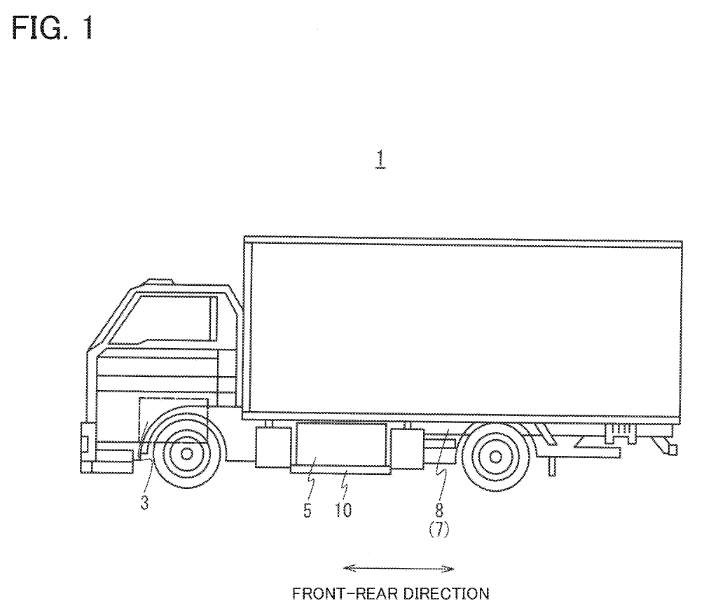

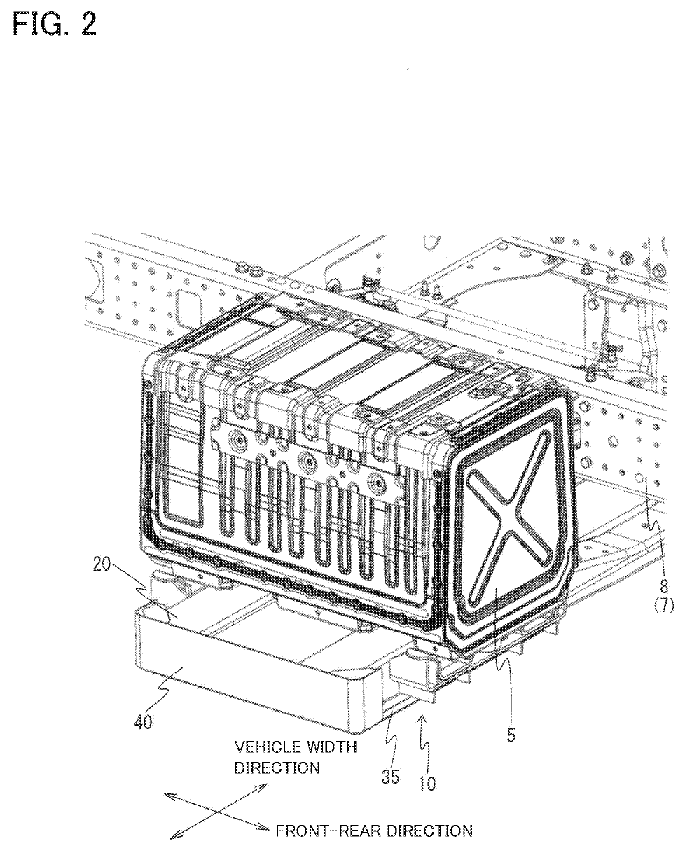

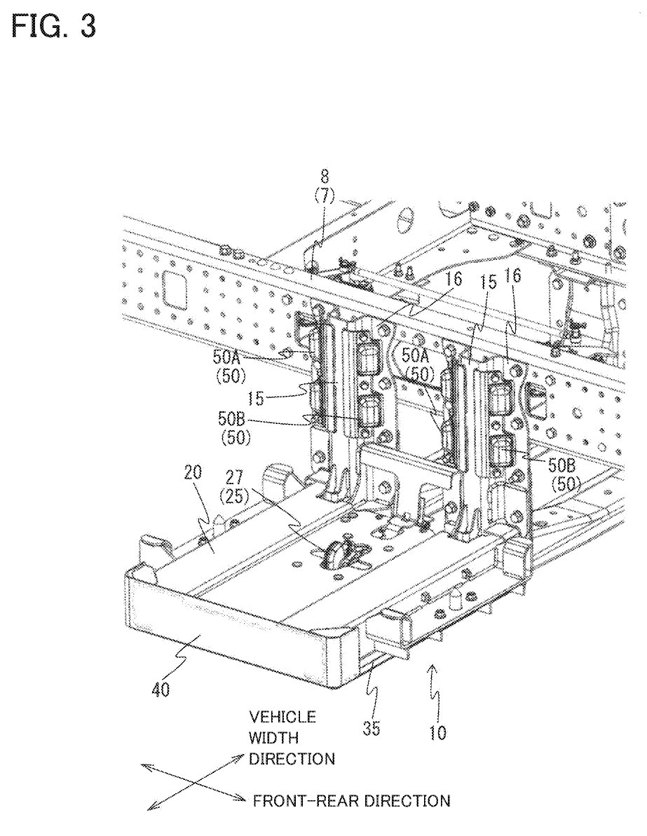

FIG. 1 is a schematic diagram illustrating a vehicle 1 according to one embodiment. FIG. 2 is a perspective view illustrating a mounting apparatus 10 on which a replaceable battery 5 is placed. FIG. 3 is a perspective view showing the mounting apparatus 10 with the replaceable battery 5 removed.

The vehicle 1 is an electric vehicle, and is, for example, a BEV (Battery Electric Vehicle). The vehicle 1 travels by driving the motor using electricity stored in a battery as a power source. Here, the vehicle 1 is a truck having a frame structure. As shown in FIG. 1, the vehicle 1 includes a motor 3, the replaceable battery 5, a vehicle body frame 7, and the mounting apparatus 10.

The motor 3 is a drive source for driving the vehicle 1. The motor 3 generates a driving force to be transmitted to the wheels of the vehicle 1. The motor 3 generates a driving force by receiving electric power from the replaceable battery 5.

The replaceable battery 5 is a battery that can be replaced. The replaceable battery 5 is a secondary battery that can be repeatedly charged. The replaceable battery 5 is, for example, a lithium-ion battery. The replaceable battery 5 can be charged from an external charger.

The vehicle body frame 7 is, as an example, a ladder frame and constitutes a framework supporting the vehicle 1. The motor 3 and the replaceable battery 5 are mounted on the vehicle body frame 7. In FIG. 1, the replaceable battery 5 is mounted on the left side7 (the near side in FIG. 1) in the vehicle width direction of the vehicle body frame, but in practice, the replaceable battery 5 is also mounted on the right side (the far side in FIG. 1) in the vehicle width direction of the vehicle body frame 7. That is, in FIG. 1, a plurality of replaceable batteries 5 (two replaceable batteries 5) are removably mounted on the vehicle body frame 7.

The vehicle body frame 7 has a pair of side frames 8. As shown in FIG. 1, the side frames 8 extend in the front-rear direction of the vehicle body of the vehicle 1. The motor 3 is fixed to the side frames 8.

The mounting apparatus 10 is, as shown in FIGS. 2 and 3, an apparatus on which the replaceable battery 5 is removably placed. The mounting apparatus 10 is attached to the vehicle body frame 7. Specifically, the mounting apparatus 10 is attached to the respective side frames 8 at both sides in the vehicle width direction. The mounting apparatus 10 is provided in a manner to be exposed to the outside, thereby facilitating placement of the replaceable battery 5 on the mounting apparatus and removal of the replaceable battery 5 from the mounting apparatus 10.

The placement and removal of the replaceable battery 5 on and from the mounting apparatus 10 are performed automatically, for example, by a replacement device provided at a replacement station. The replacement device places and removes the replaceable battery 5 on and from the mounting apparatus 10 using an arm.

### Detailed configuration of the mounting apparatus

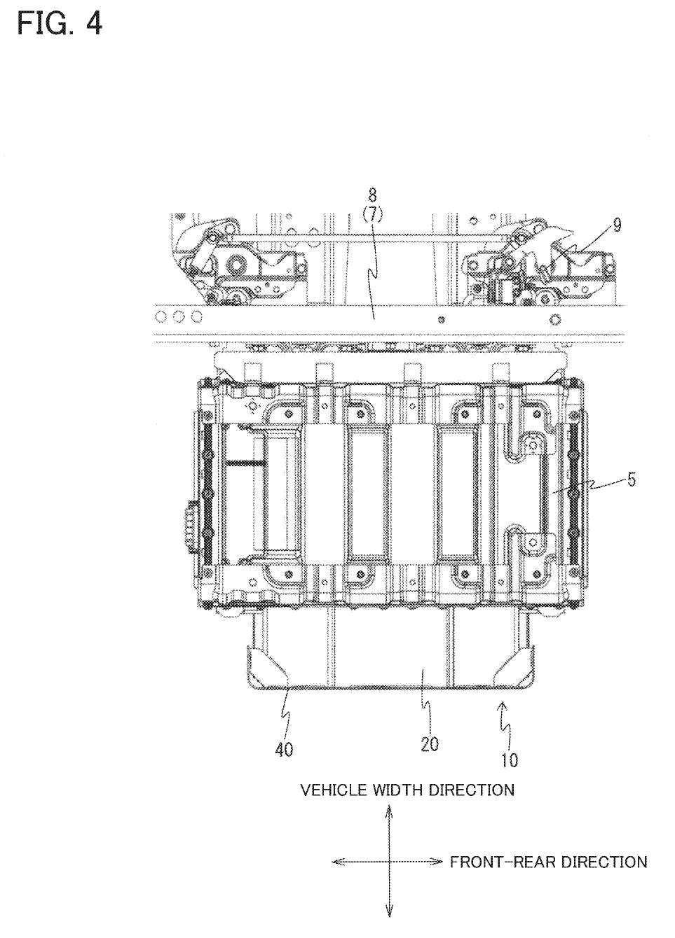

A detailed configuration of the mounting apparatus 10 will be described with reference to FIGS. 2 to 4. FIG. 4 is a plan view of the mounting apparatus 10 shown in FIG. 2.

Hereinafter, the configuration of the mounting apparatus 10 provided on the left side in the vehicle width direction shown in FIG. 2 will be described, but the configuration of the mounting apparatus 10 provided on the right side in the vehicle width direction is also the same. As shown in FIG. 3, the mounting apparatus 10 includes a coupling bracket 15, a mounting portion 20, a restraining portion 25, an under guard 35, a side guard 40, and rubber units 50A and 50B.

The coupling bracket 15 is a bracket coupled to the vehicle body frame 7. Specifically, the coupling bracket 15 is fixed to the side frame 8 by a fastening member. The coupling bracket 15 extends outward in the vehicle width direction from the side frame 8. Two coupling brackets 15 are provided at a predetermined interval in the front-rear direction. The coupling bracket 15 has an L-shape when viewed from the front-rear direction, and includes a fixing portion 16 and a support portion.

The fixing portion 16 is a portion that extends along the vertical direction, and the support portion is a portion that extends outward along the vehicle width direction. The support portion is coupled to a lower end portion of the fixing portion 16. The support portion supports the mounting apparatus 10.

The mounting portion 20 is a portion for removably placing the replaceable battery 5. The mounting portion 20 has a box shape with a predetermined thickness. The replaceable battery 5 is placed on the top plate of the mounting portion 20. The mounting portion 20 is located below the side frame 8 in the vertical direction.

The mounting portion 20 is coupled to the coupling bracket 15. Specifically, the mounting portion 20 is coupled to the support portion of the coupling bracket 15. The mounting portion 20 is movably supported by the coupling bracket 15. The mounting portion 20 moves along the vehicle width direction. Specifically, the mounting portion 20 moves between the fixed position and a replacement position by a moving mechanism. The fixed position is a position where the replaceable battery 5 is fixed to the vehicle 1. The replacement position is a position where the replaceable battery 5 is replaced. The replacement position is located outward of the fixed position in the vehicle width direction. The moving mechanism includes, for example, a guide rail that is configured to guide the movement of a slider provided in the mounting portion 20.

The restraining portion 25 restrains the replaceable battery 5 placed on the mounting portion 20. Specifically, the restraining portion 25 restricts movement of the replaceable battery 5 in a vertical direction relative to the mounting portion 20. The restraining portion 25 is provided in a central portion of the top plate of the mounting portion 20 in a manner to be exposed from the top plate.

The restraining portion 25 has a latch member 27 engageable with a striker provided at the bottom of the replaceable battery 5 (specifically, the bottom of the case of the replaceable battery 5). Due to the latch member 27 engaging with the striker of the replaceable battery 5, the vertical movement of the replaceable battery 5 is restricted. The latch member 27 is a movable member that pivots between an engagement position in which the latch member 27 engages with the striker and a disengagement position in which the engagement is released.

The vehicle body frame 7 is provided with a restraining member 9 (FIG. 4) for restricting the movement of the replaceable battery 5 in the vehicle width direction. The restraining member 9 is a latch member supported by the vehicle body frame 7. When the mounting portion 20 is positioned at the fixed position, by engaging with the striker provided on the replaceable battery 5, the restraining member 9 pulls the replaceable battery 5 inward in the vehicle width direction and restrains the replaceable battery 5. By having the restraining portion 25 and the restraining member 9 restrain the replaceable battery 5, the replaceable battery 5 is mounted on the vehicle body frame 7.

The under guard 35 has a function of preventing foreign matter from adhering to the mounting apparatus 10 from below, with the mounting apparatus 10 being exposed to the outside. The side guard 40 has a function of preventing water or mud from adhering to the mounting portion 20 from outside the mounting portion 20 in the vehicle width direction.

A pair of rubber units 50A and 50B has a function of suppressing rattling of the replaceable battery 5 caused by vibration of the vehicle 1. Specifically, the pair of rubber units 50A and 50B is provided to suppress rattling of the replaceable battery 5 in the vehicle width direction and the front-rear direction.

The rubber units 50A and 50B are provided on the coupling bracket 15. Specifically, the rubber units 50A and 50B are removably attached to the fixing portion 16 of the coupling bracket 15. The rubber units 50A and 50B are provided on each of the two fixing portions 16. Since the rubber unit 50A and the rubber unit 50B have the same configuration, they are hereinafter collectively referred to as a rubber unit 50.

### Detailed configuration of the rubber unit and attachment structure of the rubber unit

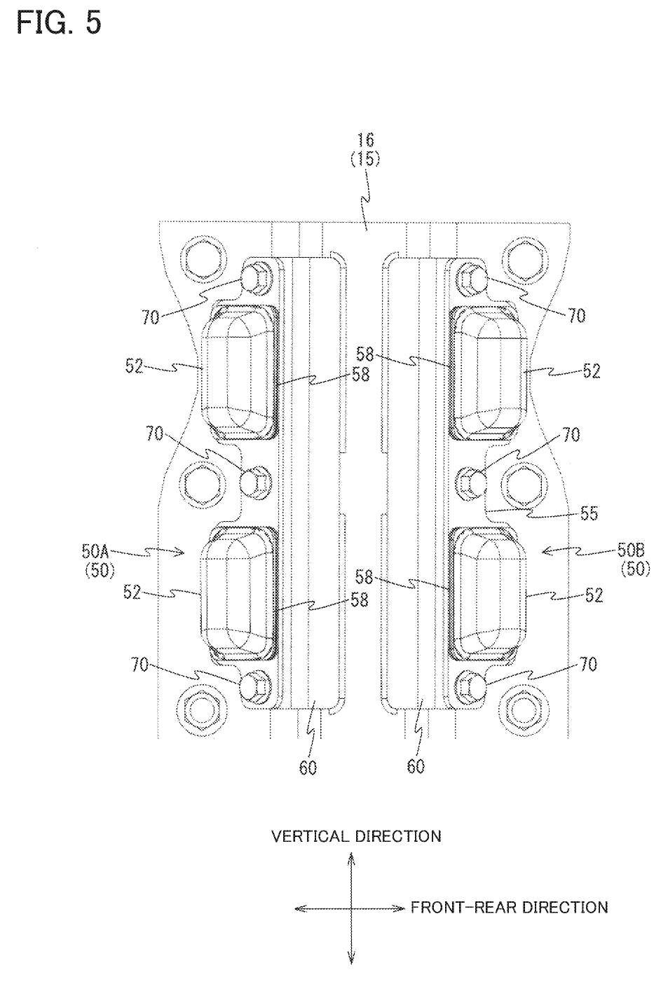

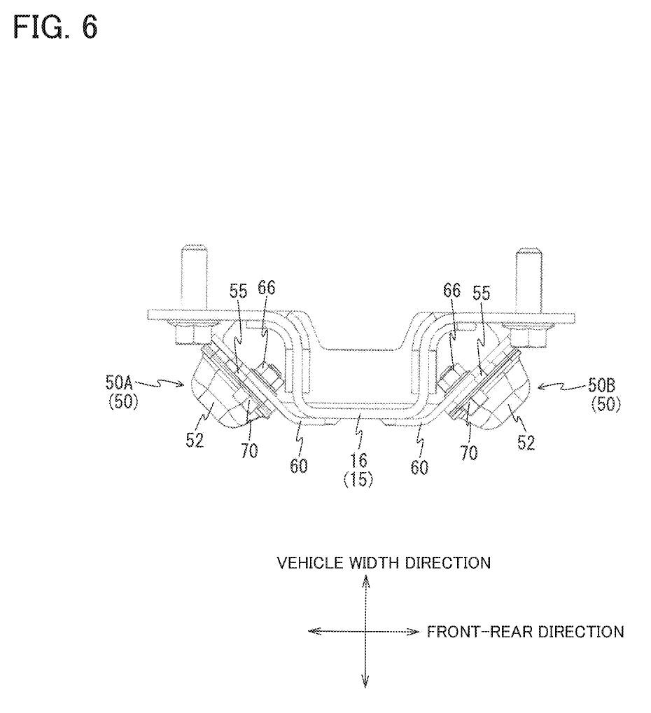

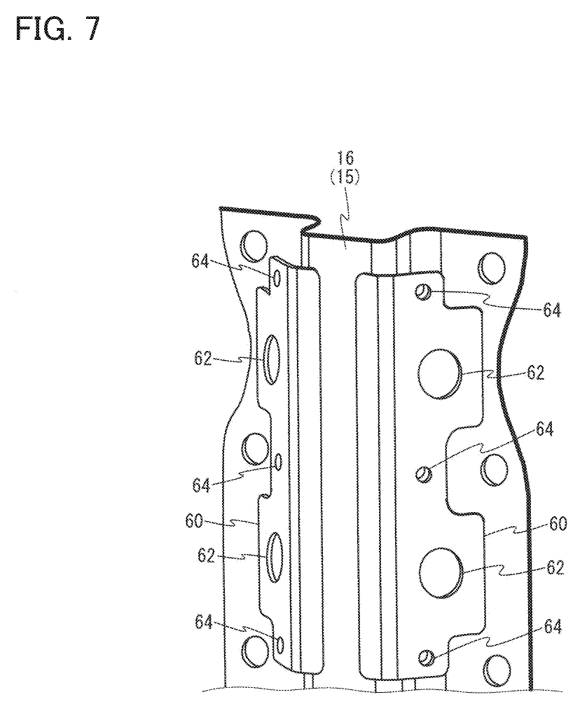

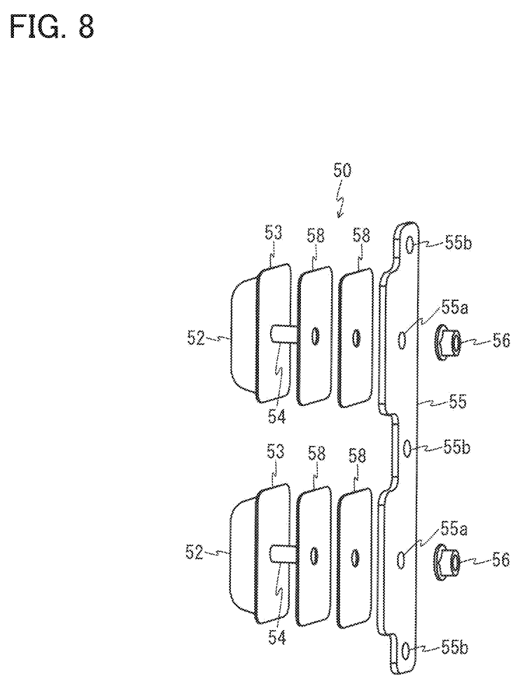

FIG. 5 is a view showing a state in which the rubber unit 50 is fixed to the coupling bracket 15. FIG. 6 is a plan view of the coupling bracket 15 and the rubber unit 50 shown in FIG. 5. FIG. 7 is a view showing the coupling bracket 15 with the rubber unit 50 removed. FIG. 8 is an exploded view of the rubber unit 50.

As shown in FIGS. 5 and 7, the rubber unit 50 is removably attached to the coupling bracket 15. As shown in FIG. 8, the rubber unit 50 includes an elastic body 52, a fixing bracket 55, and a gap adjusting member 58. In the present embodiment, the fixing bracket 55 corresponds to a second bracket.

The elastic body 52 comes into contact with the case of the replaceable battery 5 when the mounting portion 20 on which the replaceable battery 5 is placed is positioned at the fixed position. That is, the elastic body 52 is interposed between the replaceable battery 5 positioned at the fixed position on an inner side in the vehicle width direction and the coupling bracket 15. Specifically, when the mounting portion 20 is positioned at the fixed position, the restraining member 9 pulls the replaceable battery 5 in contact with the elastic body 52 inward in the vehicle width direction and restrains the replaceable battery 5. Thus, the elastic body 52 is compressed and deformed. A restoring force is generated in the compressed elastic body 52, and the restoring force acts on the replaceable battery 5, thereby suppressing rattling of the replaceable battery 5.

The elastic body 52 has a rectangular parallelepiped shape. The surface opposite to a contact surface where the elastic body 52 contacts the replaceable battery 5 is fixed to a fixing surface of a fixing plate 53. Here, the elastic body 52 and the fixing plate 53 have an integral structure. The fixing plate 53 is a flat plate, and a threaded portion 54 is provided on a rear surface of the fixing plate 53 opposite to the fixing surface so as to protrude therefrom. The threaded portion 54 protrudes in parallel with a normal direction of the rear surface.

The elastic body 52 wears down due to repeated attachment and detachment of the replaceable battery 5 or due to vibration of the vehicle 1 while in contact with the replaceable battery 5. When the elastic body 52 wears down, the function of the elastic body 52 is impaired, and thus it is necessary to replace the elastic body 52. For example, when the elastic body 52 wears down, the rubber unit 50 is replaced.

The fixing bracket 55 is a bracket to which the elastic body 52 is fixed. Specifically, the threaded portion 54 of the fixing plate 53 integrated with the elastic body 52 is threadably engaged with a nut member 56 located on the rear surface side of the fixing bracket 55, whereby the elastic body 52 is fixed to the fixing bracket 55. The thickness of the fixing bracket 55 is greater than the thickness of the fixing plate 53. The fixing bracket 55 is formed with a first through hole 55a through which the threaded portion 54 is inserted and a second through hole 55b through which a threaded portion of a fastening member 70 is inserted.

The fixing bracket 55 is removably attached to the coupling bracket 15. Specifically, the fixing bracket 55 (in other words, the rubber unit 50) to which the elastic body 52 is fixed is removably attached to a mounting bracket 60 (FIG. 6) fixed to the coupling bracket 15.

A plurality of elastic bodies 52 disposed at predetermined intervals in the vertical direction orthogonal to the longitudinal direction and the vehicle width direction are fixed to the fixing bracket 55. Here, two elastic bodies 52 are fixed to the fixing bracket 55. Since the plurality of elastic bodies 52 can be collectively attached to the coupling bracket 15 via the fixing bracket 55, workability is improved.

The gap adjusting member 58 is provided between the coupling bracket 15 and the elastic body 52, and is a member for adjusting a gap between the coupling bracket 15 and the elastic body 52. Specifically, the gap adjusting member 58 is provided between the mounting bracket 60 fixed to the coupling bracket 15 and the elastic body 52, and is configured to adjust a gap between the mounting bracket 60 and the elastic body 52. The gap adjusting member 58 is a metal plate having a predetermined thickness, and here, is a thin plate. The thickness of the gap adjusting member 58 is, for example, 1 mm to 5 mm. The gap adjusting member 58 has a rectangular shape. The shape of the gap adjusting member 58 is the same as the shape of the fixing plate 53. A through hole through which the threaded portion 54 is inserted is formed at the center of the gap adjusting member 58.

A plurality of gap adjusting members 58 can be provided between the elastic body 52 and the coupling bracket 15. For example, when the vehicle 1 is assembled, the gap between the coupling bracket 15 and the elastic body 52 can be adjusted by changing the number of the gap adjusting members 58 provided between the elastic body 52 and the coupling bracket 15. In FIG. 8, two gap adjusting members 58 are provided between the elastic body 52 and the coupling bracket 15.

As described above, the elastic body 52 exhibits its function by being elastically deformed as the restraining member 9 attached to the vehicle body frame 7 pulls the replaceable battery 5. Since many members are interposed between the coupling bracket 15 to which the elastic body 52 is fixed and the restraining member 9, the amount of deformation of the elastic body 52 may change due to interference among the members, thereby impairing the function of the elastic body 52. In contrast, in the present embodiment, even when interference among the members occurs, an operator can adjust the amount of deformation of the elastic body 52 to an appropriate level by adjusting the thickness and the number of gap adjusting members 58, and therefore deterioration of the function of the elastic body 52 can be suppressed.

Next, a detailed configuration of the coupling bracket 15 to which the rubber unit 50 is attached will be described. The coupling bracket 15 has a pair of mounting brackets 60 for mounting a pair of rubber units 50. The configuration of the pair of mounting brackets 60 is the same.

The mounting bracket 60 is fixed to the fixing portion 16 of the coupling bracket 15. Here, the mounting bracket 60 is fixed to the fixing portion 16 by welding. The mounting bracket 60 is fixed at a corner of the fixing portion 16, having a convex shape in a plan view, so as to be inclined relative to the vehicle width direction and the front-rear direction. In the present embodiment, the coupling bracket 15 corresponds to a first bracket. The mounting bracket 60 corresponds to a third bracket.

As shown in FIG. 7, the mounting bracket 60 extends along the vertical direction. The mounting bracket 60 has an L-shaped cross section in a plane orthogonal to the vertical direction. The mounting bracket 60 has a relief hole 62, a threaded hole 64, and a nut portion 66.

The relief hole 62 is a through hole for avoiding interference with the nut member 56 (FIG. 8) of the rubber unit 50. The threaded hole 64 is a through hole through which a threaded portion of the fastening member 70 for fixing the rubber unit 50 to the mounting bracket 60 is inserted.

The nut portion 66 is a fastened portion to which the fastening member 70 is fastened with the rubber unit 50 interposed therebetween. As shown in FIG. 6, the nut portion 66 is fixed to a rear surface of the mounting bracket 60. Specifically, the nut portion 66 is fixed to a portion corresponding to the threaded hole 64 on the rear surface of the mounting bracket 60 by welding.

The fastening member 70 fixes the rubber unit 50 to the coupling bracket 15 by being fastened to the nut portion 66 fixed to the rear surface of the mounting bracket 60. That is, the fastening member 70 fixes the fixing bracket 55 to which the elastic body 52 is fixed to the coupling bracket 15 by being fastened to the nut portion 66.

The fastening member 70 is a bolt member threadably engaged with the nut portion 66. In other words, a threaded portion at a distal end of the fastening member 70 is threadably engaged with the nut portion 66. A plurality of fastening members 70 are provided at predetermined intervals in the vertical direction orthogonal to the longitudinal direction and the vehicle width direction.

The nut portion 66 is fixed to the rear surface of the mounting bracket 60 by welding, so that there is no need for an operator to support the nut portion 66 when fastening the plurality of fastening members 70 to the nut portion 66, thereby facilitating the mounting operation of the rubber unit 50. In addition, when removing the rubber unit 50 for replacement, the operator can loosen the fastening member 70 without supporting the nut portion 66, thereby improving workability. In particular, when the mounting bracket 60 is fixed at the corner of the fixing portion 16, it is difficult to perform an operation of supporting the nut portion 66 during fixing, but since the nut portion 66 is fixed to the rear surface of the mounting bracket 60 as in the present embodiment, workability is significantly improved.

### Effects of the Embodiment

The mounting apparatus 10 of the above-described embodiment includes: the coupling bracket 15 in which the nut portion 66 is formed; the fixing bracket 55 removably attached to the coupling bracket 15; the elastic body 52 interposed between the replaceable battery 5 positioned on the inner side in the vehicle width direction and the coupling bracket 15; and the fastening member 70 configured to fix the fixing bracket 55 to which the elastic body 52 is fixed to the coupling bracket 15 by being fastened to the nut portion 66. When the nut portion 66 is formed on the coupling bracket 15, the operator can fix the fixing bracket 55 to which the elastic body 52 is fixed to the coupling bracket 15 merely by tightening the fastening member 70, without supporting the nut portion 66. In addition, the operator can easily remove the elastic body 52 from the coupling bracket 15 by loosening the fastening member 70, without supporting the nut portion 66.

The present disclosure is explained based on the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Furthermore, new exemplary embodiments generated by arbitrary combinations of them are included in the exemplary embodiments. Furthermore, effects of the new exemplary embodiments brought by the combinations also have the effects of the original exemplary embodiments.

What is claimed is:

1. A mounting apparatus comprising:
a first bracket fixed to a vehicle body frame and formed with a fastened portion;
a mounting portion coupled to the first bracket and configured to mount a battery so as to be movable in a vehicle width direction;
a second bracket removably attached to the first bracket;
an elastic body fixed to the second bracket and interposed between the battery positioned on an inner side in the vehicle width direction and the first bracket; and
a fastening member configured to fasten the second bracket to which the elastic body is fixed to the first bracket by being fastened to the fastened portion.

2. The mounting apparatus according to claim 1, wherein the fastened portion is a nut portion fixed to the first bracket by welding, and
the fastening member is a bolt member threadably engaged with the nut portion.

3. The mounting apparatus according to claim 2, wherein the first bracket includes:
a fixing portion fixed to the vehicle body frame and having a convex shape in a plan view; and
a third bracket fixed to a corner of the fixing portion, and
the nut portion is fixed to a rear surface of the third bracket.

4. The mounting apparatus according to claim 3, wherein the third bracket is fixed at a corner of the fixing portion so as to be inclined relative to the vehicle width direction and a front-rear direction of the vehicle body frame.

5. The mounting apparatus according to claim 1, wherein a plurality of the elastic bodies disposed at predetermined intervals in the vertical direction are fixed to the second bracket.

6. The mounting apparatus according to claim 1, wherein a plurality of the fastening members are provided at predetermined intervals in the vertical direction.

7. The mounting apparatus according to claim 1, further comprising:
a gap adjusting member provided between the elastic body and the first bracket and configured to adjust a gap between the elastic body and the first bracket.

8. The mounting apparatus according to claim 7, wherein the gap adjusting member is a metal plate having a predetermined thickness, and
a plurality of the gap adjusting members are provided between the elastic body and the first bracket.

9. The mounting apparatus according to claim 7, wherein the gap adjusting member is interposed between the elastic body and the second bracket.

10. The mounting apparatus according to claim 7, further comprising:
a restraining member supported by the vehicle body frame and configured to pull the battery in contact with the elastic body inward in the vehicle width direction and restrain the battery.
